(19) United States
(12) Patent Application Publication
(10) Pub. No.: US 2026/0021857 A1
(43) Pub. Date: Jan. 22, 2026

(54) SEAT PACK FOR A BICYCLE

(71) Applicant: TAILFIN LIMITED, Bristol (GB)

(72) Inventors: Nicholas BROADBENT, North Somerset (GB); Robert PHILLIPS, Bristol (GB); Edward COWAN, Bristol (GB)

(21) Appl. No.: 19/268,148

(22) Filed: Jul. 14, 2025

(30) Foreign Application Priority Data
Jul. 19, 2024 (GB) 2410641.1

(51) Int. Cl. B62J 9/26; B62J 9/27

(52) U.S. Cl. CPC B62J 9/26; B62J 9/27

(57) ABSTRACT

There is provided a seat pack for a bicycle, the seat pack comprising: a bag component defining an internal volume and having a main opening at one end; and a structural support component received within the internal volume; wherein an outer surface of the structural support component is provided with a first mounting portion for attachment to a seatpost of the bicycle and a second mounting portion for attachment to a saddle of the bicycle; wherein the bag component comprises one or more openings which receive the first mounting portion and the second mounting portion such that the first and second mounting portions project externally from the bag component.

### CROSS-REFERENCE TO RELATED APPLICATION

This application claims priority to United Kingdom Patent Application Serial No. 2410641.1 filed Jul. 19, 2024, which is incorporated herein by reference.

### FIELD

The disclosure generally relates to a seat pack for a bicycle.

### BACKGROUND

Bikepacking and touring are popular outdoor activities requiring efficient solutions for carrying necessary gear on a bicycle. There are various types of bag which can be attached to a bicycle for this purpose. For example, a seat pack (sometimes also referred to as a saddlebag, although this term is typically used in connection with smaller bags for carrying tools and other similar items, rather than luggage) may be attached to a bicycle via the seatpost and/or saddle such that it sits under the rear of the saddle. However, seat packs suffer from a variety of issues that limit their usability. These problems range from lateral and vertical instability, susceptibility to mud clogging, excessive weight, propensity for breakage, limited compatibility with various seat posts and saddles, time-consuming and tricky fitting and removal processes, and vulnerability to damage and wear from the rear wheel and saddle.

It is therefore desirable to address or alleviate one or more of these issues experienced with conventional seat packs.

### SUMMARY

In accordance with an aspect of the disclosure there is provided a seat pack for a bicycle, the seat pack comprising:
a bag component defining an internal volume and having a main opening at one end; and
a structural support component received within the internal volume;
wherein an outer surface of the structural support component is provided with a first mounting portion for attachment to a seatpost of the bicycle and a second mounting portion for attachment to a saddle of the bicycle;
wherein the bag component comprises one or more openings which receive the first mounting portion and the second mounting portion such that the first and second mounting portions project externally from the bag component.

The first mounting portion may receive a seatpost strap and/or the second mounting portion receives a saddle strap.

The second mounting portion may receive separate first and second saddle straps.

The bag component may comprise a pair of buckles on either side of the bag component which are configured to engage the first and second saddle straps.

The bag component may comprise a pair of straps on either side of the bag component which are configured to engage buckles provided on the first and second saddle straps

The second mounting portion may comprise a first section which receives the first saddle strap and a second section which receives the second saddle strap.

The first and second sections of the second mounting portion may be spaced laterally from one another.

A channel may be provided between the first and second sections of the second mounting portion for receiving a portion of the seatpost.

The channel may be recessed below the level of the first and second sections of the second mounting portion.

The channel may be recessed into the internal volume of the bag component.

The first and/or second mounting portion may comprise a slot which receives the seatpost and/or saddle straps.

The first and/or second mounting portions may comprise a plurality of slots which are spaced along a length of the first and/or second mounting portions to allow a position of the seatpost and/or saddle straps to be adjusted.

The bag component may be sealed to the structural support component around the perimeter of the one or more openings.

The structural support component may comprise an upper portion, a lower portion and a front portion.

The upper, lower and front portions of the structural support component may abut against upper, lower and front surfaces of the bag component.

The first mounting portion may be provided on the front portion of the structural support component and the second mounting portion may be provided on the upper portion of the structural support component.

The lower portion of the structural support component may comprise a threaded boss.

The seat pack may further comprise one or more bumper pads configured to abut against a portion of the saddle.

The one or more bumper pads may be provided on the structural support component and project through corresponding openings in the bag component.

The one or more bumper pads may define a portion for abutting against rails of the saddle and/or a portion for abutting against a rear of the saddle.

The first mounting portion may comprise an abutment surface which has a V-shaped cross-section.

The one or more openings may comprise a first opening for receiving the first mounting portion and a second opening for receiving the second mounting portion.

The structural support component may comprise one or more stiffening ribs.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a perspective view of a seat pack according to an embodiment;

FIG. 2 is a lower perspective view of the seat pack;

FIG. 3 is an exploded view of the seat pack;

FIG. 4 is an enlarged view of a structural support component of the seat pack;

FIG. 5 shows the seat pack attached to a bicycle;

FIGS. 6 and 7 are close-up views showing the attachment of the seat pack to the seatpost and saddle;

FIGS. 8 and 9 show the seat pack attached with the saddle in first and second positions respectively;

FIG. 10 is a side view of the seat pack;

FIG. 11 is a cross-sectional view along the plane shown in FIG. 10; and

FIG. 12 is an enlarged view of a portion of FIG. 11.

### DETAILED DESCRIPTION

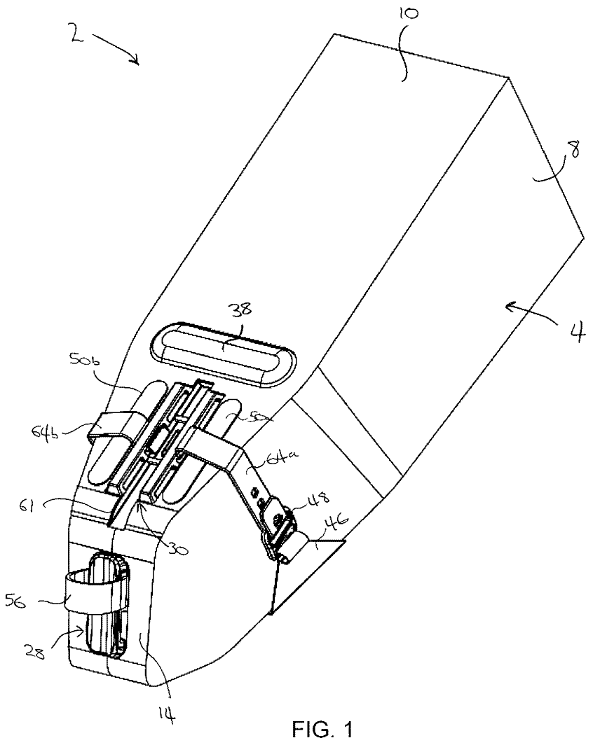

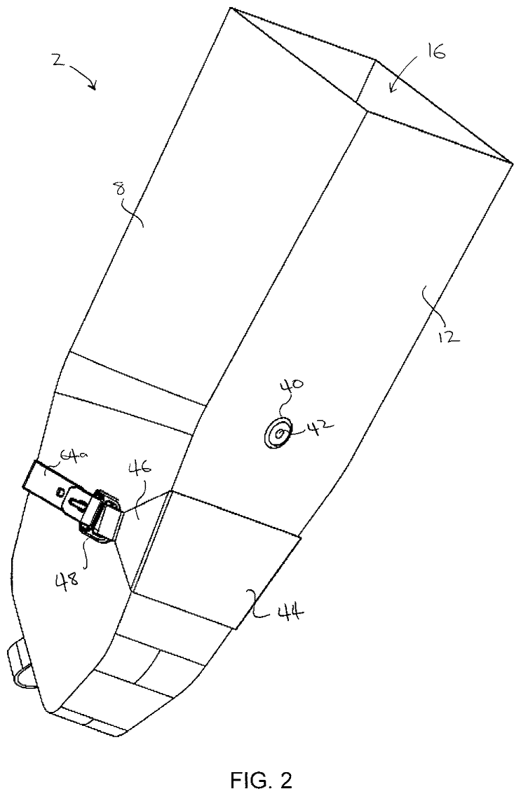

FIGS. 1 and 2 show a seat pack 2 according to an embodiment of the invention.

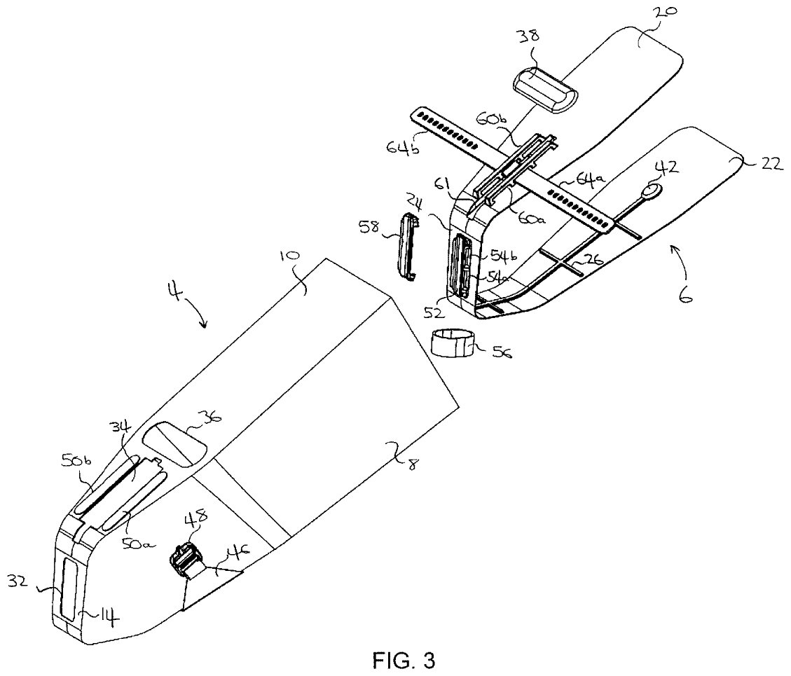

As shown in FIG. 3, the seat pack 2 is generally formed from a bag component 4 and a structural support component 6 which is received within the bag component 4.

The bag component 4 comprises a pair of side surfaces 8, an upper surface 10, a lower surface 12, and a front surface 14. The bag component 4 has an opening 16 at an opposing end to the front surface 14. The bag component 4 defines an internal volume which may be filled with contents, such as clothes or sleeping equipment, via the opening 16. The bag component 4 may use a roll-top closure system to seal the opening 16. For example, the seat pack 2 may be provided with one or more side release clips to hold the bag component 4 in a closed configuration. The roll-top closure can be used to vary the internal volume of the bag component 4 so as to securely hold the contents therewithin. The clips may be provided on cinch straps which allow the position of the clips to be adjusted.

In this example, the side surfaces 8 and upper and lower surfaces 10, 12 taper towards the front surface 14 such that the cross-sectional area of the internal volume reduces along at least part of the length of the bag component 4. The bag component 4 may be described as having a nosecone shape i.e. it is like a tapered open box.

The bag component 4 may be formed from a material such as TPU-coated Nylon or other similar durable fabric, and the construction can be either welded or sewn together.

The structural support component 6 is received within the bag component 4 to help the bag component 6 maintain its shape. The structural support component 6 may be formed from a relatively rigid material like plastic, metal or carbon.

The structural support component 6 comprises an upper portion 20, a lower portion 22 and a front portion 24. The structural support component is therefore substantially U-shaped. The structural support component 6 is configured to conform to the shape of the internal volume of the bag component 4. In particular, with the structural support component 6 located within the bag component 4, the upper portion 20, the lower portion 22 and the front portion 24 lie against the inner side of the corresponding upper surface 10, lower surface 12 and front surface 14 of the bag component 6. It will be appreciated that the upper and lower portions 20, 22 may extend over only part of the upper and lower surfaces 10, 12 so as to leave an unstructured rear section of the bag component 4. This therefore allows the internal volume of the bag component 4 to be reduced using the roll-top closure system, as described previously.

In other examples, the structural support component 6 may further comprise side portions which conform to the side surfaces of the bag component 4.

An inner surface of the structural support component 6 comprises stiffening ribs 26 which increase the rigidity of the structural support component 6. In particular, the stiffening ribs 26 comprise a lengthwise rib and a plurality of widthwise ribs which are spaced along and intersect the lengthwise rib.

An outer surface of the structural support component 6 is provided with a first mounting portion 28 and a second mounting portion 30. The first mounting portion 28 is provided on the front portion 24 and the second mounting portion 30 is provided on the upper portion 20 of the structural support component 6. The first mounting portion 28 and the second mounting portion 30 may be integrally formed with the front portion 24 and the upper portion 20 respectively. The first and second mounting portions 28, 30 will be described in further detail below.

The bag component 4 comprises a first opening 32 in the front surface 14 and a second opening 34 in the upper surface 10. The first and second openings 32, 34 are configured to receive the first and second mounting portions 28, 30 respectively such that the first and second mounting portions 28, 30 project therefrom, as can be seen in FIG. 1. The bag component 4 is stitched or welded (or otherwise sealed) to the structural support component 6 around the perimeter of the first and second openings 32, 34 (i.e., around the perimeter of the first and second mounting portions 28, 30) to seal the bag component 4.

A further opening 36 is provided in the upper surface 10 of the bag component 4 which receives a bumper pad 38 provided on the upper portion 20 of the structural support component 6. The bumper pad 38 is formed from a soft rubber or similar material. For example, the bumper pad 38 may be formed from TPU or TPE which is overmolded onto the upper portion 20 or may be formed from Nitrile or EPDM as a separate component which is attached to the upper surface 10. The bumper pad 38 extends in a widthwise direction across the upper portion 20.

A further opening 40 is provided in the lower surface 12 of the bag component 4 which receives a threaded boss 42 provided on the lower portion 22 of the structural support component 6, as can be seen in FIG. 2. The threaded boss 42 may be used to attach a light to the seat pack 2.

Again, the bag component 4 is stitched or welded (or otherwise sealed) to the structural support component 6 around the perimeter of these further openings 36, 40 to seal the bag component 4.

The bag component 4 may be attached to the structural support component 6 at other areas of the upper portion 20, lower portion 22 and front portion 24. For example, the structural support component 6 may be glued to the bag component at other areas of the upper portion 20, lower portion 22 and front portion 24. Although not shown, the internal volume of the bag component 4 may be provided with a lining material which covers and conceals the structural support component 6.

The bag component 4 further comprises a support sling 44 which passes under the lower surface 12 and forms a pair of tabs 46 on either side of the bag component 4. The support sling 44 may be welded or stitched (or otherwise attached) to the lower surface 12 of the bag component 4 and also, optionally, to the lower portion 22 of the structural support component 6. The support sling 12 may also be welded or stitched (or otherwise attached) to the side surfaces 8 of the bag component 4. Alternatively, the support sling 12 may not be attached to the side surfaces 8 of the bag component 4 such that the tabs 46 are freely movable. The tabs 46 are each provided with a buckle 48. Each buckle 48 may be of the general form disclosed in our co-pending patent application GB2205537.0. Such buckles 48 are particularly suited to use in wet and muddy conditions. In other examples, the buckles 48 may be provided directly on the side surfaces 8 of the bag component 4, rather than on a common support sling 44. It will be appreciated that this arrangement may also be reversed such that the buckles are attached to the second mounting portion 30 of the structural support component 6 and straps are provided on the bag component (e.g. on the support sling 12)

In addition, the bag component 4 is provided with a pair of bumper pads 50a, 50b which are disposed on either side of the second opening 34 which receives the second mounting portion 30. The bumper pads 50a, 50b extend in a lengthwise direction. In other examples, the bumper pads 50a, 50b may be provided on the structural support component 6 in a similar manner to the bumper pad 38, with corresponding openings provided in the bag component 4. In other examples, the bumper pad 38 and bumper pads 50a, 50b may be formed as a single component. For example, a U-shaped bumper pad may be provided around the second opening 34 to replace the separate bumper pads 38, 50a, 50b. As a further alternative, the rectangular bumper pad may be used which entirely encircles the second opening 34.

The first mounting portion 28 is used to attach the seat pack 2 to a seatpost of the bicycle. The first mounting portion 28 may be generally of the same configuration as is disclosed in our co-pending patent application GB2302346.8, to which reference is directed.

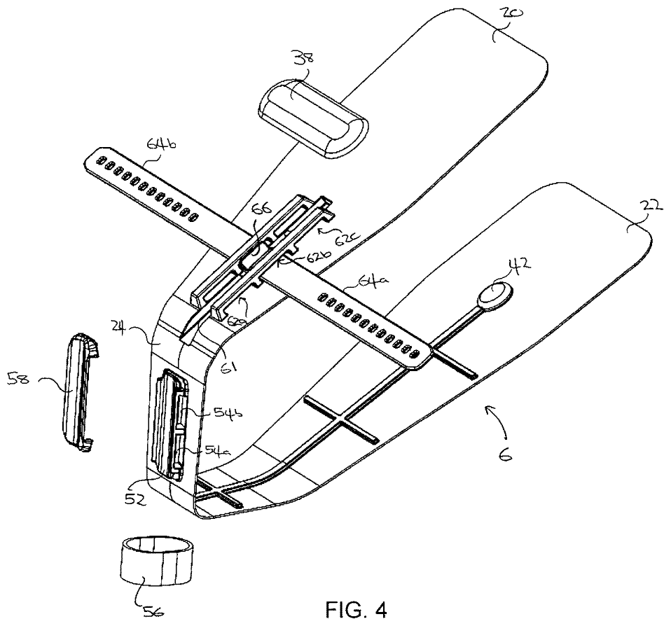

As best seen in FIG. 4, the first mounting portion 28 comprises an abutment surface 52 and first and second slots 54a, 54b which are provided behind the abutment surface 52 (i.e., between the abutment surface 52 and the front surface 10 of the bag component 4). The first and second slots 54a, 54b are configured to receive a seatpost strap 56. The first and second slots 54a, 54b are spaced along the length of the first mounting portion 28 and thus allow a vertical position of the seatpost strap 56 to be adjusted. In other examples, the first mounting portion 28 may comprise only a single slot or more than two slots.

The seatpost strap 56 may be of the general configuration disclosed in our co-pending patent application GB2205537.0, to which reference is directed. In particular, the seatpost strap 56 may be formed from a resilient material like TPU, which has both stretch and flex, and which is resistant to both mud clogging and wear and tear.

A resilient boot 58 is provided which is received over the abutment surface 52 of the first mounting portion 28. The boot 58 is formed from a softer resilient rubber-like material, such as EPDM or Nitrile, which is mechanically affixed (or otherwise attached) to the abutment surface. Alternatively, the boot 58 may formed from TPE or TPU, for example, which is overmolded onto the abutment surface 52. The boot 58 is configured to maintain the first mounting portion 28 in position by offering a pliable interface between the seatpost and the first mounting portion 28. The boot 58 therefore avoids movement on the seatpost and thus prevents damage (e.g., scratching) of the seatpost.

The abutment surface 52 and/or boot 58 may have a V-shaped cross-section which allows the first mounting portion 28 to be secured against any diameter and shape of seatpost.

The second mounting portion 30 is formed as first and second sections 60a, 60b which are separated by a channel 61. Each of the first and second sections 60a, 60b comprise three slots 62a, 62b, 62c (which may be referred to as a front slot 62a, a middle slot 62b and a rear slot 62c) which are spaced along their length, although any other number of slots (including a single slot) may be used.

A first saddle strap 64a is threaded through the first section 60a and a second saddle strap 64b is threaded through the second section 60b. The first and second saddle straps 64a, 64b may be of the general configuration disclosed in our co-pending patent application GB2205537.0, to which reference is directed. In particular, as with the seatpost strap 56, the first and second saddle straps 64a, 64b may be formed from a resilient material like TPU, which has both stretch and flex, and which is resistant to both mud clogging and wear and tear.

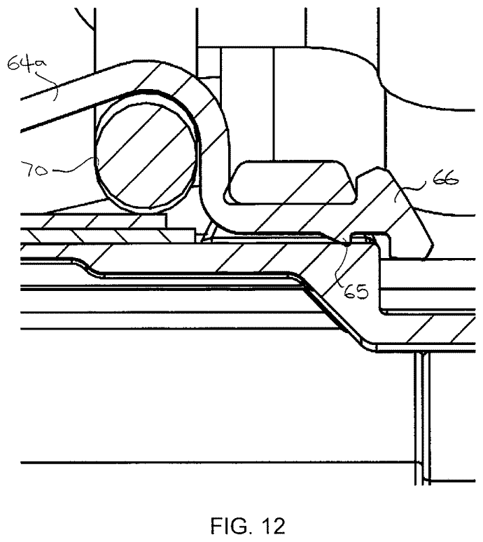

As best seen in FIG. 12, the first and second saddle straps 64a, 64b each have a head portion 66 which is sized so as to be retained by the slot 62a, 62b, 62c being used. The first and second saddle straps 64a, 64b further comprise a retaining ridge 65 adjacent the head portion 66 which engages a corresponding groove formed in the structural support component 6 to hold the strap in position.

The first and second saddle straps 64a, 64b are threaded outwards such that the head portions 66 are held between the first and second sections 60a, 60b and the distal free portions of the first and second saddle straps 64a, 64b extend away from one another and down the respective side surfaces 8 of the bag component 4 where they can be fastened to the buckles 48.

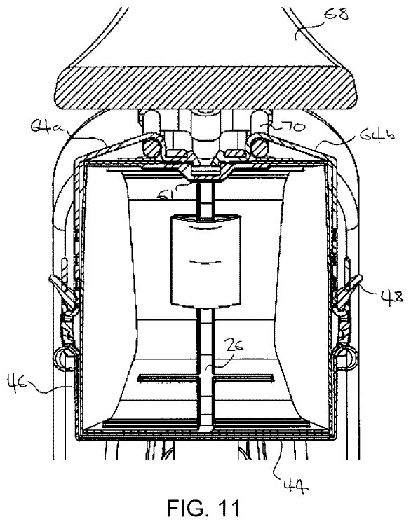

As best seen in FIG. 11, the channel 61 is recessed below the level of the first and second sections 60a, 60b and below the upper surface 10 of the bag component 4.

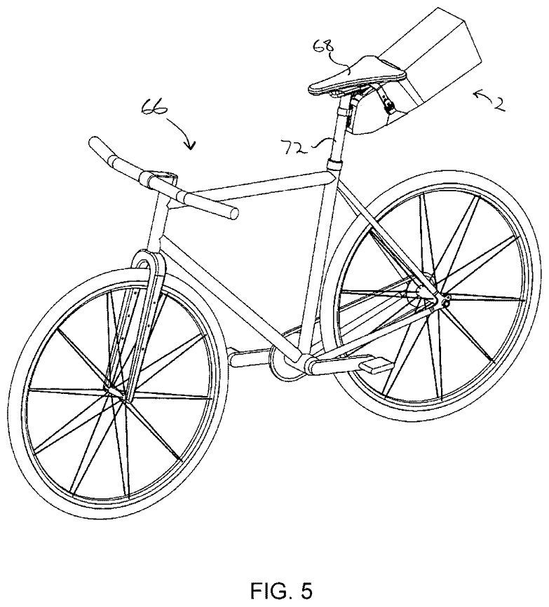

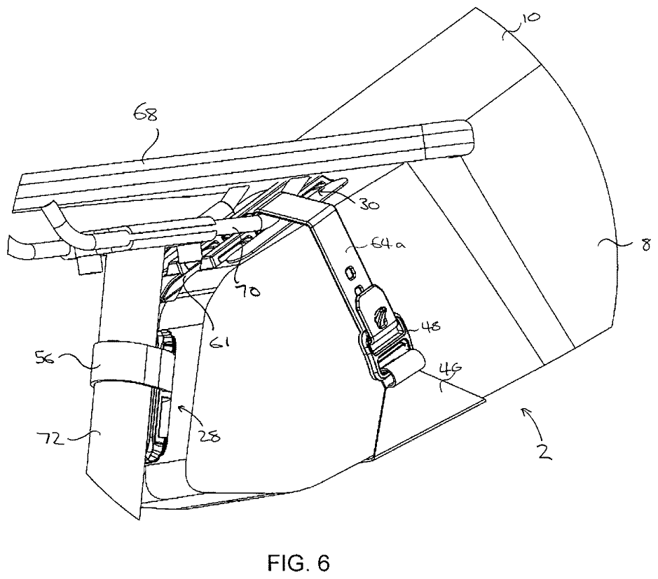

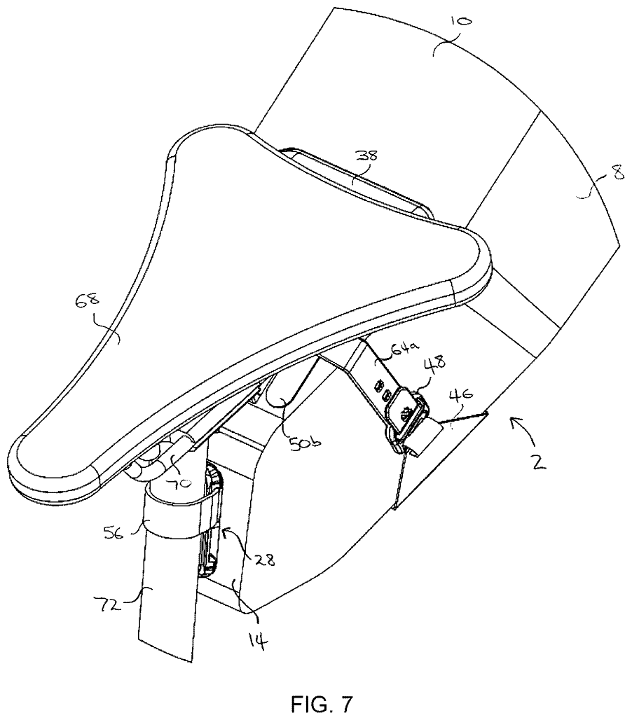

FIGS. 5 to 7 show the seat pack 2 installed on a bicycle 66. As shown, the seat pack 2 is located underneath the rear of a saddle 68 of the bicycle 66 which is supported by a seatpost 72. The first and second saddle straps 64a, 64b are looped over respective rails 70 of the saddle 68. As shown in FIG. 6, each of the first and second saddle straps 64a, 64b pass over (in a laterally outward direction) an inclined rear portion of the rail 70 which does not form part of the usable length of the rail 70 that is clamped by the seatpost 72. The first and second saddle straps 64a, 64b can then be pulled down towards the buckles 48 which draws the seat pack 2 upwards into contact with the underside of the saddle. In particular, the bumper pad 38 contacts a rear of the saddle 68 and the bumper pads 50a, 50b contact the underside of the rails 70. The first and second saddle straps 64a, 64b can then be fastened to the buckles 48 under tension. The bumper pads 38, 50a, 50b provide a snug fit and accommodate differences in saddles. They also aid in reducing noise and enhancing overall stability, as well as avoiding damage to the saddle 68.

As best seen in FIG. 6, the channel 61 of the second mounting portion 30 receives a rear portion of a saddle clamp of the seatpost.

Similarly, the seatpost strap 56 can be passed around the seatpost 72 and through one of the slots 54a, 54b of the first mounting portion 28 so as bring the abutment surface 52/boot 58 into engagement with a rear surface of the seatpost 72.

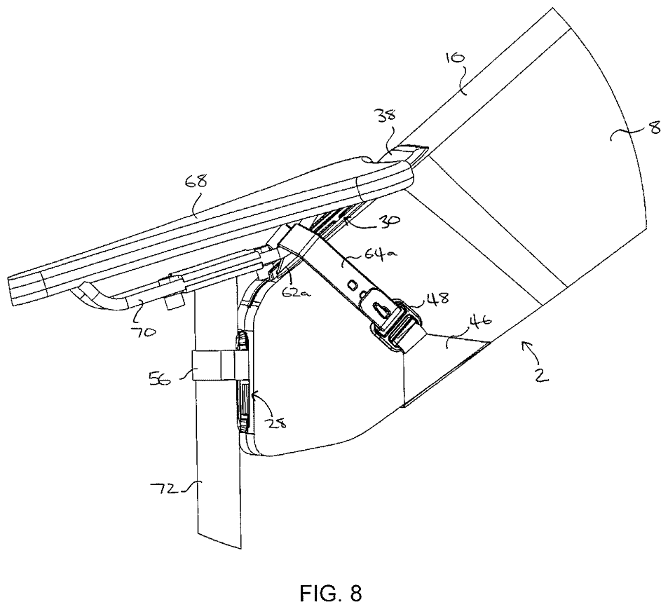

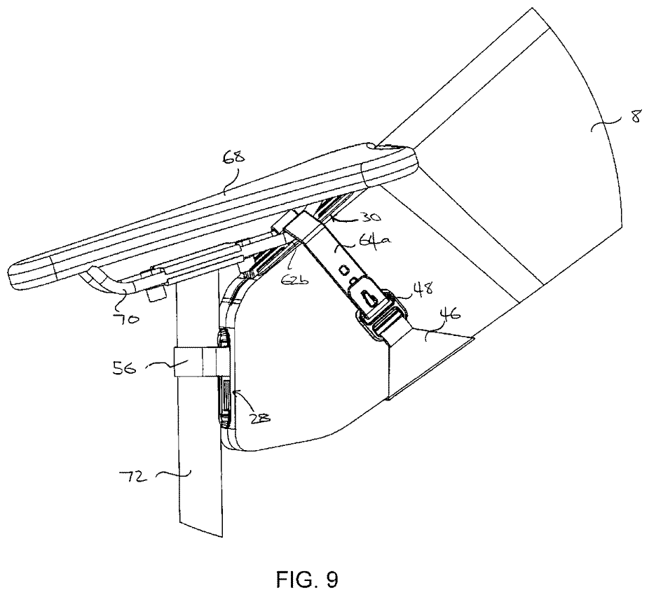

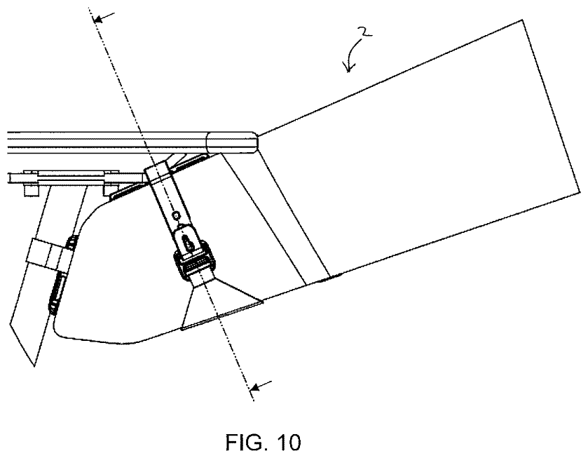

The seat pack 2 is able to accommodate different fore and aft positions of the saddle 68 relative to the seatpost 72 by using the different slots 62a, 62b, 62c of the second mounting portion 30. For example, FIG. 8 shows the saddle 68 in a relatively forward position (i.e., clamped at the rear of the rails 70) which is accommodated by using the front slot 62a, whereas FIG. 9 shows the saddle 68 in a relatively rearward position (i.e., clamped at the front of the rails 70) which is accommodated by using the middle slot 62b (or rear slot 62c).

As described, the seatpost strap 56 and the first and second saddle straps 64a, 64b may be formed from a resilient material like TPU, which has both stretch and flex. Therefore, in the event of a crash, the straps will stretch and not break.

The lower portion 22 of the structural support component 6 provides protection and increases the resilience of the underside of the seat pack 2. This may be particularly important when the seat pack 2 is fitted to mountain bikes where the rear wheel may contact the underside of the seat pack 2 as a result of rear suspension travel or the use of an adjustable “dropper” seatpost.

Although the first and second mounting portions 28, 30 have been described as having multiple slots to accommodate different positions of the straps, in other examples the first and second mounting portions 28, 30 may comprise a single slot formed in a carrier which is slidable along a guide rail or track to allow the position to be adjusted.

The bag component 4 has been described as having separate first and second openings 32, 34 which receive the first and second mounting portions 28, 30 respectively. However, in other examples, a single opening may be provided in the bag component 4 which receives both the first and second mounting portions 28, 30. Such a single opening spans the upper portion 10 and front portion 14 of the bag component 4. The bag component 4 can be stitched or welded (or otherwise sealed) to the structural support component 6 around the perimeter of this single opening (i.e., around a perimeter encompassing both the first and second mounting portions 28, 30) to seal the bag component 4. This single opening could also be extended to encompass the bumper pad 38 and the bumper pads 50a, 50b where they are provided on the structural support component 6.

The seat pack 2 described herein offers superior stability, flexibility, durability, and compatibility. In particular, the seat pack 2 successfully addresses issues of lateral and vertical instability by providing a unique mounting arrangement which uses a structural support component 6 that is located internally within the bag component 4 but which includes mounting portions that project through openings in the bag component 4 to form a direct connection with the seatpost and saddle. The seat pack 2 uses specialized straps and buckles that are resistant to mud clogging. The straps have a stretchable nature that safeguards them from snapping during a crash. The seat pack 2 is designed to be universally compatible with all types of seatposts, saddles, and saddle rails. The seat pack 2 is quick to fit and remove during use. The seat pack 2 also showcases impressive robustness against wear and tear, including potential damage from the rear wheel.

The invention is not limited to the embodiments described herein, and may be modified or adapted without departing from the scope of the present invention.

1. A seat pack for a bicycle, the seat pack comprising:
a bag component defining an internal volume and having a main opening at one end; and
a structural support component received within the internal volume;
wherein an outer surface of the structural support component is provided with a first mounting portion for attachment to a seatpost of the bicycle and a second mounting portion for attachment to a saddle of the bicycle;
wherein the bag component comprises one or more openings which receive the first mounting portion and the second mounting portion such that the first and second mounting portions project externally from the bag component.

2. A seat pack as claimed in claim 1, wherein the first mounting portion receives a seatpost strap and/or the second mounting portion receives a saddle strap.

3. A seat pack as claimed in claim 2, wherein the second mounting portion receives separate first and second saddle straps.

4. A seat pack as claimed in claim 3, wherein the bag component comprises a pair of buckles on either side of the bag component which are configured to engage the first and second saddle straps; or wherein the bag component comprises a pair of straps on either side of the bag component which are configured to engage buckles provided on the first and second saddle straps.

5. A seat pack as claimed in claim 3, wherein the second mounting portion comprises a first section which receives the first saddle strap and a second section which receives the second saddle strap.

6. A seat pack as claimed in claim 5, wherein the first and second sections of the second mounting portion are spaced laterally from one another.

7. A seat pack as claimed in claim 6, wherein a channel is provided between the first and second sections of the second mounting portion for receiving a portion of the seatpost.

8. A seat pack as claimed in claim 7, wherein the channel is recessed below the level of the first and second sections of the second mounting portion.

9. A seat pack as claimed in claim 8, wherein the channel is recessed into the internal volume of the bag component.

10. A seat pack as claimed in claim 2, wherein the first and/or second mounting portion comprises a slot which receives the seatpost and/or saddle straps.

11. A seat pack as claimed in claim 10, wherein the first and/or second mounting portions comprise a plurality of slots which are spaced along a length of the first and/or second mounting portions to allow a position of the seatpost and/or saddle straps to be adjusted.

12. A seat pack as claimed in claim 1, wherein the bag component is sealed to the structural support component around the perimeter of the one or more openings.

13. A seat pack as claimed in claim 1, wherein the structural support component comprises an upper portion, a lower portion and a front portion.

14. A seat pack as claimed in claim 13, wherein the upper, lower and front portions of the structural support component abut against upper, lower and front surfaces of the bag component.

15. A seat pack as claimed in claim 13, wherein the first mounting portion is provided on the front portion of the structural support component and the second mounting portion is provided on the upper portion of the structural support component.

16. A seat pack as claimed in claim 13, wherein the lower portion of the structural support component comprises a threaded boss.

17. A seat pack as claimed in claim 1, further comprising one or more bumper pads configured to abut against a portion of the saddle.

18. A seat pack as claimed in claim 17, wherein the one or more bumper pads are provided on the structural support component and project through corresponding openings in the bag component.

19. A seat pack as claimed in claim 17, wherein the one or more bumper pads define a portion for abutting against rails of the saddle and/or a portion for abutting against a rear of the saddle.

20. A seat pack as claimed in claim 1, wherein the first mounting portion comprises an abutment surface which has a V-shaped cross-section.

21. A seat pack as claimed in claim 1, wherein the one or more openings comprises a first opening for receiving the first mounting portion and a second opening for receiving the second mounting portion.

22. A seat pack as claimed in claim 1, wherein the structural support component comprises one or more stiffening ribs.
